(19) United States
(12) Patent Application Publication
(10) Pub. No.: US 2026/0312762 A1
(43) Pub. Date: Oct. 8, 2026

(54) WIRELESS COMMUNICATION METHOD AND DEVICE THEREOF

(71) Applicant: ZTE CORPORATION, Shenzhen (CN)

(72) Inventors: Xuan MA, Shenzhen (CN); Mengzhu CHEN, Shenzhen (CN); Jun XU, Shenzhen (CN); Bo DAI, Shenzhen (CN); Qiujin GUO, Shenzhen (CN)

(73) Assignee: ZTE CORPORATION, Shenzhen (CN)

(21) Appl. No.: 19/481,742

(22) PCT Filed: May 15, 2023
(86) PCT No.: PCT/CN2023/094278

§ 371 Date: Nov. 5, 2025

(51) Int. Cl. H04L 5/00; H04B 7/06; H04W 76/28

(52) U.S. Cl. CPC H04L 5/0051; H04B 7/0626; H04L 5/0044; H04L 5/0055; H04W 76/28

(57) ABSTRACT

A wireless communication method for use in a wireless terminal is disclosed. The method comprises detecting a physical layer signaling from a wireless network node, wherein the physical layer signaling comprises an energy saving indication, and transmitting, to the wireless network node, feedback information in response to a detection of the physical layer signaling.

### TECHNICAL FIELD

This document is directed generally to wireless communications, and in particular to 5G communications.

### BACKGROUND

In comparison with 4G base stations, 5G base stations have much higher power consumption because of increased number of transmission/receive antennas, high frequency band, etc. To build a green and sustainable wireless communication system, the network energy efficiency needs to be increased.

In order to reduce the network energy consumption, some mechanisms, such as cell DTX (discontinuous transmission) and/or DRX (discontinuous reception), spatial elements adaptation, dynamic power adaptation, are introduced. In addition, an L1 (layer 1) signaling (e.g., DCI (downlink control information) indicating the Cell DTX and/or DRX activation/deactivation may be beneficial for the network energy saving. If the L1 signaling is introduced, how to determine whether the signaling is transmitted successfully needs further discussions.

### SUMMARY

This document relates to methods, systems, and devices for signaling transmissions, and in particular to methods, systems, and devices for ensuring a transmitting side and a receiving side have a mutual understanding for the signaling transmission.

The present disclosure relates to a wireless communication method for use in a wireless terminal. The method comprises:
detecting a physical layer signaling from a wireless network node, wherein the physical layer signaling comprises an energy saving indication, and
transmitting, to the wireless network node, feedback information in response to a detection of the physical layer signaling.

Various embodiments may preferably implement the following features:

Preferably, the energy saving indication comprises at least one of: an indication to indicate an activation or deactivation of a cell discontinuous communication configuration, wherein the cell discontinuous communication configuration is for a cell discontinuous transmission (DTX) or a cell discontinuous reception (DRX), an indication to indicate one or more power offsets, an indication to indicate one or more antenna ports, an indication to indicate one or more channel state information reference signal (CSI-RS) resources, an indication indicates one or more CSI-RS resources groups/sets, an indication indicates one or more subsets of antenna port indices, or an indication indicates one or more CSI report configurations or sub-configurations.

Preferably, the feedback information is hybrid automatic repeat request (HARQ) acknowledge information.

Preferably, transmitting, to the wireless network node, the feedback information in response to the detection of the physical layer signaling comprises transmitting, to the wireless network node, the feedback information having a positive acknowledgement value in response to a successful detection of the physical layer signaling and the feedback information having a negative acknowledgement value in response to a failed detection of the physical layer signaling.

Preferably, transmitting, to the wireless network node, the feedback information in response to the detection of the physical layer signaling comprises transmitting, to the wireless network node, only the feedback information having the positive acknowledgement value in response to the successful detection of the physical layer signaling.

Preferably, transmitting, to the wireless network node, the feedback information in response to the detection of the physical layer signaling comprises not transmitting, to the wireless network node, the feedback information having the negative acknowledgement value in response to the failed detection of the physical layer signaling.

Preferably, transmitting, to the wireless network node, the feedback information in response to the detection of the physical layer signaling comprises transmitting, to the wireless network node, only the feedback information having the negative acknowledgement value in response to the failed detection of the physical layer signaling.

Preferably, transmitting, to the wireless network node, the feedback information in response to the detection of the physical layer signaling comprises not transmitting, to the wireless network node, the feedback information having the positive acknowledgement value in response to the successful detection of the physical layer signaling.

Preferably, the feedback information is transmitted N symbols after a pre-defined symbol, wherein N is a positive integer, and the pre-defined symbol is the first symbol or the last symbol of a transmission occasion for the physical layer signaling.

Preferably, N is determined based on at least one of: a smallest subcarrier spacing (SCS) configuration between a first SCS configuration of the physical layer signaling and a second SCS configuration of a physical uplink control channel carrying the feedback information, processing capability of the wireless terminal, a pre-determined value, or one or more fixed value configured by high layer parameter.

Preferably, the detection of the physical layer signaling is in a slot n and the feedback information in response to the detection of the physical layer signaling is transmitted in a slot n+k, wherein n is an integer and k is a positive integer.

Preferably, k is indicated by the physical layer signaling, configured by a high layer parameter or predetermined.

Preferably, the feedback information comprises one or more information bits corresponding to one or more physical layer signalings.

Preferably, the one or more HARQ-ACK information bits are transmitted in the same slot.

Preferably, the one or more HARQ-ACK information bits are joint coded or presented by the same PUCCH resource or sequence.

Preferably, the one or more physical layer signalings are transmitted in different occasions and comprise the same or different indication information.

Preferably, the feedback information is transmitted on a dedicated physical uplink control channel (PUCCH) resource set comprising one or more PUCCH resources configured for the feedback information.

Preferably, the feedback information is transmitted on a common PUCCH resource set comprising one or more PUCCH resources.

Preferably, the feedback information is transmitted via at least one of a physical uplink control channel (PUCCH) format 0 or a PUCCH format 1.

Preferably, at least one of a PUCCH resource or PUCCH resource set used for transmitting at least one feedback bit of the feedback information is determined based on at least one of a pre-determined resource, a predetermined resource set, a length of the HARQ-ACK information bits, a PUCCH resource set index, a PUCCH resource index, a number of control channel elements (CCEs) in a CORESET of a physical layer signaling reception, an index of a first CCE for the physical layer signaling reception, a value of the PUCCH resource indicator field in the DCI format, or at least one bit value of the at least one feedback bit.

The present disclosure relates to a wireless communication method for use in a wireless network node. The method comprises:
transmitting, to a wireless terminal, a physical layer signaling comprising an energy saving indication, and
receiving, from the wireless terminal feedback information in response to a detection of the physical layer signaling.

Various embodiments may preferably implement the following features:
Preferably, the energy saving indication comprises at least one of: an indication to indicate an activation or deactivation of a cell discontinuous communication configuration, wherein the cell discontinuous communication configuration is for a cell discontinuous transmission (DTX) or a cell discontinuous reception (DRX), an indication to indicate one or more power offsets, an indication to indicate one or more antenna ports, an indication to indicate one or more channel state information reference signal (CSI-RS) resources, an indication indicates one or more CSI-RS resources groups/sets, an indication indicates one or more subsets of antenna port indices, or an indication indicates one or more CSI report configurations or sub-configurations.
Preferably, the feedback information is hybrid automatic repeat request (HARQ) acknowledge information.
Preferably, the feedback information comprises a positive acknowledgement value in response to a successful detection of the physical layer signaling and a negative acknowledgement value in response to a failed detection of the physical layer signaling.
Preferably, the feedback information comprises only the positive acknowledgement value in response to the successful detection of the physical layer signaling.
Preferably, the feedback information comprises only the negative acknowledgement value in response to the failed detection of the physical layer signaling.
Preferably, the feedback information is received N symbols after a pre-defined symbol, wherein N is a positive integer, and the pre-defined symbol is the first symbol or the last symbol of a transmission occasion for the physical layer signaling.
Preferably, N is determined based on at least one of: a smallest subcarrier spacing (SCS) configuration between a first SCS configuration of the physical layer signaling and a second SCS configuration of a physical uplink control channel carrying the feedback information, processing capability of the wireless terminal, a pre-determined value, or one or more fixed value configured by high layer parameter.
Preferably, the detection of the physical layer signaling is in a slot n and the feedback information in response to the detection of the physical layer signaling is received in a slot n+k, wherein n is an integer and k is a positive integer.
Preferably, k is indicated by the physical layer signaling, configured by a high layer parameter or predetermined.
Preferably, the feedback information comprises one or more information bits corresponding to one or more physical layer signalings.
Preferably, the one or more HARQ-ACK information bits are transmitted in the same slot.
Preferably, the one or more HARQ-ACK information bits are joint coded or presented by the same PUCCH resource or sequence.
Preferably, the one or more physical layer signalings are transmitted in different occasions and comprise the same or different indication information.
Preferably, the feedback information is received on a dedicated physical uplink control channel (PUCCH) resource set comprising one or more PUCCH resources configured for the feedback information.
Preferably, the feedback information is received on a common PUCCH resource set comprising one or more PUCCH resources.
Preferably, the feedback information is received via at least one of a physical uplink control channel (PUCCH) format 0 or a PUCCH format 1.
Preferably, at least one of a PUCCH resource or PUCCH resource set used for transmitting at least one feedback bit of the feedback information is determined based on at least one of a pre-determined resource, a predetermined resource set, a length of the HARQ-ACK information bits, a PUCCH resource set index, a PUCCH resource index, a number of control channel elements (CCEs) in a CORESET of a physical layer signaling reception, an index of a first CCE for the physical layer signaling reception, a value of the PUCCH resource indicator field in the DCI format, or at least one bit value of the at least one feedback bit.

The present disclosure relates to a wireless terminal. The wireless terminal comprises:
a processor, configured to detect a physical layer signaling from a wireless network node, wherein the physical layer signaling comprises an energy saving indication, and
a communication unit, configured to transmitting, to the wireless network node, feedback information in response to a detection of the physical layer signaling.

Various embodiments may preferably implement the following feature:
Preferably, the processor is further configured to perform any of the aforementioned wireless communication methods.

The present disclosure relates to a wireless network node. The wireless network node comprises: a communication unit, configured to: transmit, to a wireless terminal, a physical layer signaling comprising an energy saving indication, and receive, from the wireless terminal feedback information in response to a detection of the physical layer signaling.

Various embodiments may preferably implement the following feature:
Preferably, the wireless network node further comprises a processor configured to perform any of the aforementioned wireless communication methods.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The invention is specified by the independent claims. Preferred embodiments are defined in the dependent claims. In the following description, although numerous features may be designated as optional, it is nevertheless acknowledged that all features comprised in the independent claims are not to be read as optional.

### BRIEF DESCRIPTION OF THE DRAWINGS

The above and other aspects and their implementations are described in greater detail in the drawings, the descriptions, and the claims.

FIG. 1 shows a schematic diagram of a network according to an embodiment of the present disclosure.

FIG. 2 shows an example of a schematic diagram of a wireless terminal according to an embodiment of the present disclosure.

FIG. 3 shows an example of a schematic diagram of a wireless network node according to an embodiment of the present disclosure.

FIG. 4 shows a flowchart of a method according to an embodiment of the present disclosure.

FIG. 5 shows a flowchart of a method according to an embodiment of the present disclosure.

### DETAILED DESCRIPTION

The present disclosure provides a feedback scheme to guarantee a base station and a UE (user equipment) have a same understanding after the (layer 1 or physical layer) signaling transmission.

In an embodiment, the UE detects a first signaling and provides HARQ-ACK information in response to a detection of the first signaling.

In an embodiment, the gNB (i.e., base station) transmits a first signaling and receives a feedback (HARQ-ACK) from the UE.

In an embodiment, the first signaling comprises at least one of an indication to indicate activation/deactivation of a cell DTX and/or DRX configuration, an indication to indicate one or more power offsets, an indication to indicate one or more antenna ports, an indication to indicate one or more CSI-RS resources, an indication to indicate one or more CSI-RS resources groups/sets, an indication to indicate one or more subsets of antenna port indices, an indication to indicate one or more CSI report configurations or sub-configurations.

In some embodiments, the power offset comprises at least one of:
the powerControlOffset, which is the assumed ratio of PDSCH EPRE (Energy per resource element) to NZP (Non-Zero Power) CSI-RS EPRE, or
powerControlOffsetSS, which is the assumed ratio of NZP CSI-RS EPRE to SS/PBCH block EPRE.

In some embodiments, the cell DTX and/or DRX configuration comprises at least one of a cell DTX/DRX cycle, a cell DTX/DRX ON duration timer, a cell DTX/DRX inactivity timer, a cell DTX/DRX offset, or a cell DTX/DRX pattern or pattern index.

In some embodiments, the UE receives configuration(s) of the cell DTX or the cell DRX, wherein the cell DTX or the cell DRX configuration is used to determine an active time and or a non-active time of the cell DTX or the cell DRX. In some embodiments, the cell DTX and/or the cell DRX configuration is activated when the configuration is configured. In some embodiments, the cell DTX and/or the cell DRX takes effect immediately after the configuration is completed.

During the non-active time for the cell DTX, the UE does not receive one or more first channels or signals. In some embodiments, the first channel or signal includes at least one of SPS (Semi Persistent Scheduling) PDSCH (physical downlink shared channel), UE specific PDCCH (physical downlink control channel), or CSI-RS (channel state information reference signal) for channel measurements.

During the non-active time for the cell DRX, the UE does not transmit one or more second channels or signals. In some embodiments, the second channel or signal includes at least one of CG (configured grant) PUSCH (physical uplink shared channel), SRS (sounding reference signal), or SR (scheduling request).

In some embodiments, the CSI-RS resource group/set includes one or more CSI-RS resources. In some examples, the one or more CSI-RS resources in one CSI-RS resource group/set associated with the number of antenna ports, or power offset values.

In some embodiments, the CSI report configuration includes one or more CSI report sub-configurations.

In some embodiments, each CSI report sub-configuration corresponds/associated with a subset of port indices or a CSI-RS resource set/group.

### HARQ-ACK Reporting Mode

In some embodiments, the UE provides the HARQ-ACK information for the detection of the first signaling according to at least one of a first HARQ-ACK reporting mode, a second HARQ-ACK reporting mode, a third HARQ-ACK reporting mode.

For the first HARQ-ACK reporting mode, the UE generates HARQ-ACK information with ACK (i.e., positive acknowledgement) value when the UE correctly detects the first signaling; otherwise, the UE generates HARQ-ACK information with NACK (negative acknowledgement) value.

In some embodiments, a HARQ-ACK information bit value of 0 represents a NACK while a HARQ-ACK information bit value of 1 represents an ACK.

For the second HARQ-ACK reporting mode, the UE does not transmit a HARQ-ACK information with NACK values, UE transmits the HARQ-ACK information only when the HARQ-ACK information bit has ACK value.

For example, the UE generates the HARQ-ACK information with ACK value (e.g., bit ‘1’) when a UE correctly detects a first signaling and provided to the gNB in the corresponding resource. When there is no first signaling detected, no corresponding HARQ-ACK information is generated.

For the third HARQ-ACK reporting mode, the UE does not transmit a HARQ-ACK information with ACK values, and the UE transmits the HARQ-ACK information only when the HARQ-ACK information bit has NACK value.

For example, the UE generates the HARQ-ACK information with NACK value (e.g., bit ‘0’) when the UE does not detect a first signaling correctly and provides the HARQ-ACK information to the gNB in the corresponding resource. When a first signaling is detected, no corresponding HARQ-ACK information is generated.

### HARQ-ACK Reporting Timeline

In some embodiments, the UE provides the HARQ-ACK information in response to a detection of the first signaling after N symbols from the last/first symbol of the first signaling transmission occasion, wherein N is positive integer (e.g., N>0).

In an embodiment, the determination of N is associated with at least one of:
the smallest SCS (sub-carrier spacing) configuration between the SCS configuration of the first signaling and the SCS configuration of a PUCCH with the HARQ-ACK information in response to the first signaling (denoted as μ),
the UE processing capability, or
one or more fixed value configured by high layer parameter.

For example, for UE processing capability 2: N=7 for μ=0, N=7.5 for μ=1, and N=15 for μ=2; otherwise, N=14 for μ=0, N=16 for μ=1, N=27 for μ=2, N=31 for μ=3, N=124 for μ=5, and N=248 for μ=6.

In some embodiments, the UE detects the first signaling in a slot n, and provides the HARQ-ACK information in response to the detection of the first signaling in a slot n+k, where n and k are integers.

In an embodiment, the k is a number of slots and indicated by the first signaling, configured by high layer parameters (e.g., RRC parameters), or predetermined.

In some embodiments, one or more values for k are configured by high layer parameter(s), and a bit field in the first signaling is used to indicate which value is used for k.

In some embodiments, more than one HARQ-ACK information corresponding to one or more first signalings are to be transmitted in the same slot. In this embodiment, the more than one HARQ-ACK information bits are joint coded or presented by the same PUCCH resource/or sequence. The one or more first signalings are transmitted in different occasions and comprise the same or different indication information.

In some embodiments, more than one HARQ-ACK information corresponding to one or more first signalings are transmitted in the same slot, the HARQ-ACK information bits are joint coded.

In some embodiments, one bit HARQ-ACK information will be provided. For example, when all the HARQ-ACK information bit corresponding to the first signaling are the ACK value, the reported HARQ-ACK information is provided with a ACK value. When all the HARQ-ACK information bit corresponding to the first signaling are the NACK value, the reported HARQ-ACK information is provided with a NACK value. In some examples, as long as there is one ACK value occurs among all the HARQ-ACK information bit corresponding to the first signaling, the reported HARQ-ACK information is provided with a ACK value. In some other examples, as long as there is one NACK value occurs among all the HARQ-ACK information bit corresponding to the first signaling, the reported HARQ-ACK information is provided with a NACK value.

In some embodiments, more than one HARQ-ACK information corresponding to one or more first signalings are transmitted in the same slot. The HARQ-ACK information bits may be ordered according to the order of the receptions of the first signalings and multiplexed in the same PUCCH resource. Note that the one or more first signalings are transmitted in different occasions and comprise the same or different indication information.

In some embodiments, the combination of the multiple HARQ-ACK information bits are transmitted with the same PUCCH resource or sequence.

For example, the UE detects a first signaling in slot n, and the k is indicated as 2. In this example, the HARQ-ACK information for the first signaling in slot n is expected to be provided in slot n+2. The UE may detect another first signaling in slot n+1 and the k for the first signaling in slot n+1 is indicated as 1. The HARQ-ACK information for the first signaling in slot n+1 is expected to be provided also in slot n+2. If the first signaling in slot n is detected successfully and the first signaling in slot n+1 is not detected successfully, the HARQ-ACK information bits ‘10’ are provided in slot n+2.

In some embodiments, more than one HARQ-ACK information corresponding to one or more first signaling are to be transmitted in the same slot, the more than one HARQ-ACK information are transmitted in different symbols according to an order of the receptions of the first signalings.

### HARQ-ACK Resource

In some embodiments, the UE provides the HARQ-ACK information in a PUCCH resource.

In some embodiments, a dedicated PUCCH resource set which includes one or more PUCCH resources or a common PUCCH resource set or a common PUCCH resource is configured for the HARQ-ACK information transmission.

In some embodiments, the dedicated PUCCH resource or the dedicated PUCCH resource set is configured by a UE specific signaling. In some embodiments, the dedicated PUCCH resource or resource set are configured by a SIB (system information block).

In some embodiments, the selection of PUCCH resource set or the PUCCH resource for the HARQ-ACK information transmission is determined by at least one of:
a length of the HARQ-ACK information bits;
a PUCCH resource set or PUCCH resource index;
a HARQ-ACK reporting mode;
one of a number of CCEs in a CORESET of a first signaling reception;
an index of a first CCE for the first signaling reception;
a higher layer signaling;
an indication in the first signaling reception; or.
a value of the PUCCH resource indicator field in the DCI format.

In some embodiments, a dedicated PUCCH resource set which includes one or more PUCCH resources are configured for the HARQ-ACK information transmission.

In some embodiments, the UE selects the PUCCH resource set or the PUCCH resource according to the length of the HARQ-ACK information bits and/or the PUCCH resource set or PUCCH resource index. For example, when the number of the HARQ-ACK information bits is not greater than A (A is a positive integer, e.g., 2), the PUCCH resource set with a resource set index 0 (or the smallest resource set index) is used for the HARQ-ACK information transmission. When the number of the HARQ-ACK information bits is larger than A and is not greater than N1, the PUCCH resource set or PUCCH resource with a resource set index 1 (or the second smallest resource set index) is used for the HARQ-ACK information transmission, wherein N1 is equal to the maximum payload size of the resource set with the resource index 0 or N1 is equal to the maximum UCI (uplink control information) length. When the number of the HARQ-ACK information bits are larger than N1 and no more than N2, the PUCCH resource set with a resource set index 2 (or the third smallest resource set index) is used for the HARQ-ACK information transmission, wherein N2 is equal to the maximum payload size of the resource set with the resource set index 1 or equal to the maximum UCI length. Otherwise, the PUCCH resource set with a resource set index 3 is used for the HARQ-ACK information transmission.

In some embodiments, the UE selects a PUCCH resource or PUCCH resource set with an index, wherein the determination of the index is associated with at least one of a number of CCEs (Channel Control Elements) in a CORESET (control resource set) of a first signaling reception, an index of a first CCE for the first signaling reception, or a value of the PUCCH resource indicator field in the DCI format.

In some embodiments, the resource set for HARQ-ACK information transmission is a common PUCCH resource set provided by pucch-ResourceCommon.

In some embodiments, the UE selects a PUCCH resource with an index, wherein the determination of the index is associated with at least one of a number of CCEs in a CORESET of a first signaling reception, an index of a first CCE for the first signaling reception, a value of the PUCCH resource indicator field in the DCI format, or the bit length of the HARQ-ACK information.

In an embodiment, each PUCCH resource in the resource set is corresponding to a PUCCH format, a first symbol, a duration, a PRB offset, and a cyclic shift index set for a PUCCH transmission.

In some embodiments, a PUCCH resource is configured for the HARQ-ACK information transmission. In some embodiments, the UE transmits the PUCCH according to the PUCCH resource configuration for the ACK value.

In some embodiments, the PUCCH format used for the HARQ-ACK information transmission comprises at least one of a PUCCH format 0 or a PUCCH format 1.

In some embodiments, the UE selects a PUCCH resource from a set of PUCCH resources for the HARQ-ACK information transmission based on the values of the HARQ-ACK information bits.

In some embodiments, the HARQ-ACK information with the ACK value corresponds to a first PUCCH resource and the HARQ-ACK information with NACK value corresponds to a second PUCCH resource.

In an embodiment for the first HARQ-ACK reporting mode, the HARQ-ACK information bit with value ‘0’ corresponds to the first PUCCH resource in a resource list and the HARQ-ACK information bit with value ‘1’ corresponds to the second PUCCH resource in the resource list. The resource list may comprise the candidate PUCCH resources. The resource list can be the dedicated PUCCH resource set or the common PUCCH resource set.

In an embodiment for the second HARQ-ACK reporting mode, the HARQ-ACK information bit with the ACK value corresponds to the first PUCCH resource from the resource list, wherein the resource list comprises the candidate PUCCH resources. The HARQ-ACK information bit with the NACK value has no corresponding PUCCH resource.

In an embodiment for the third HARQ-ACK reporting mode, the HARQ-ACK information bit with NACK value corresponds to the second PUCCH resource from the resource list, wherein the resource list comprises the candidate PUCCH resources. The HARQ-ACK information bit with the ACK value has no corresponding PUCCH resource.

In some embodiments, more than one first signaling are transmitted within a duration and the HARQ-ACK information are reported in the same PUCCH resource, wherein more than one HARQ-ACK information bits are generated for the first signaling.

In an embodiment for the first HARQ-ACK reporting mode, the HARQ-ACK information bit corresponds to each first signaling is generated and the HARQ-ACK information bits are ordered according to the order of the receptions of the first signalings and multiplexed in the same PUCCH resource.

In some embodiments, the PUCCH resource is selected according to the values of the HARQ-ACK information bits. For example, the PUCCH resource is selected according to the following table 1.

TABLE 1
Mapping of values of HARQ-ACK information bits to PUCCH
resources for the first HARQ-ACK reporting mode

| Value of HARQ-ACK information bits | | | | PUCCH resource |
|---|---|---|---|---|
| {0} | {0, 0} | {0, 0, 0} | {0, 0, 0, 0} | 1^{st} PUCCH resource |
| | | | | from resourceList |
| | {0, 1} | {0, 0, 1} | {0, 0, 0, 1} | 2^{nd} PUCCH resource |
| | | | | from resourceList |
| | {1, 0} | {0, 1, 0} | {0, 0, 0, 0} | 3^{rd} PUCCH resource |
| | | | | from resourceList |
| | {1, 1} | {0, 1, 1} | {0, 0, 1, 1} | 4^{th} PUCCH resource |
| | | | | from resourceList |
| | | {1, 0, 0} | {0, 1, 0, 0} | 5^{th} PUCCH resource |
| | | | | from resourceList |
| | | {1, 0, 1} | {0, 1, 0, 1} | 6^{th} PUCCH resource |
| | | | | from resourceList |
| | | {1, 1, 0} | {0, 1, 1, 0} | 7^{th} PUCCH resource |
| | | | | from resourceList |
| | | {1, 1, 1} | {0, 1, 1, 1} | 8^{th} PUCCH resource |
| | | | | from resourceList |
| | | | {1, 0, 0, 0} | 9^{th} PUCCH resource |
| | | | | from resourceList |
| | | | {1, 0, 0, 1} | 10^{th} PUCCH resource |
| | | | | from resourceList |
| | | | {1, 0, 1, 0} | 11^{th} PUCCH resource |
| | | | | from resourceList |
| | | | {1, 0, 1, 1} | 12^{th} PUCCH resource |
| | | | | from resourceList |
| | | | {1, 1, 0, 0} | 13^{th} PUCCH resource |
| | | | | from resourceList |
| | | | {1, 1, 0, 1} | 14^{th} PUCCH resource |
| | | | | from resourceList |
| | | | {1, 1, 1, 0} | 15^{th} PUCCH resource |
| | | | | from resourceList |
| | | | {1, 1, 1, 1} | 16^{th} PUCCH resource |
| | | | | from resourceList |

In an embodiment for the second HARQ-ACK reporting mode, the UE does not generate HARQ-ACK information for the first signalings if all of the first signalings transmitted within the duration are not correctly detected. Otherwise, more than one HARQ-ACK information bits are generated and each bit corresponds to one first signaling transmitted within the duration. For instance, bit ‘1’ denotes the ACK value and bit ‘0’ denotes the NACK value.

In some embodiments, the PUCCH resource may be selected according to the values of the HARQ-ACK information bits. For example, the PUCCH resource may be selected according to the following table 2.

TABLE 2
Mapping of values of HARQ-ACK information bits to PUCCH
resources for the second HARQ-ACK reporting mode

| Value of HARQ-ACK information bits | | | | PUCCH resource |
|---|---|---|---|---|
| {1} | {1, 1} | {1, 1, 1} | {1, 1, 1, 1} | 1^{st} PUCCH resource |
| | | | | from resourceList |
| | {1, 0} | {1, 0, 0} | {1, 0, 0, 0} | 2^{nd} PUCCH resource |
| | | | | from resourceList |
| | {0, 1} | {0, 1, 0} | {0, 1, 0, 0} | 3^{rd} PUCCH resource |
| | | | | from resourceList |
| | | {1, 1, 0} | {1, 1, 0, 0} | 4^{th} PUCCH resource |
| | | | | from resourceList |
| | | {0, 0, 1} | {0, 0, 1, 0} | 5^{th} PUCCH resource |
| | | | | from resourceList |
| | | {1, 0, 1} | {1, 0, 1, 0} | 6^{th} PUCCH resource |
| | | | | from resourceList |
| | | {0, 1, 1} | {0, 1, 1, 0} | 7^{th} PUCCH resource |
| | | | | from resourceList |
| | | | {1, 1, 1, 0} | 8^{th} PUCCH resource |
| | | | | from resourceList |
| | | | {0, 0, 0, 1} | 9^{th} PUCCH resource |
| | | | | from resourceList |
| | | | {1, 0, 0, 1} | 10^{th} PUCCH resource |
| | | | | from resourceList |
| | | | {0, 1, 0, 1} | 11^{th} PUCCH resource |
| | | | | from resourceList |
| | | | {1, 1, 0, 1} | 12^{th} PUCCH resource |
| | | | | from resourceList |
| | | | {0, 0, 1, 1} | 13^{th} PUCCH resource |
| | | | | from resourceList |
| | | | {1, 0, 1, 1} | 14^{th} PUCCH resource |
| | | | | from resourceList |
| | | | {0, 1, 1, 1} | 15^{th} PUCCH resource |
| | | | | from resourceList |

In an embodiment for the third HARQ-ACK reporting mode, the UE does not generate HARQ-ACK information for the first signalings if all of the first signalings transmitted within the duration are correctly detected. Otherwise, more than one HARQ-ACK information bits are generated and each bit corresponds to single first signaling transmitted within the duration. For instance, bit ‘1’ denotes the ACK value and bit ‘0’ denotes the NACK value.

In some embodiments, the PUCCH resource is selected according to the values of the HARQ-ACK information bits. For example, the PUCCH resource is selected according to the following table 3.

TABLE 3
Mapping of values of HARQ-ACK information bits to PUCCH
resources for the third HARQ-ACK reporting mode

| Value of HARQ-ACK information bits | | | | PUCCH resource |
|---|---|---|---|---|
| {0} | {0, 0} | {0, 0, 0} | {0, 0, 0, 0} | 1^{st} PUCCH resource |
| | | | | from resourceList |
| | {1, 0} | {1, 0, 0} | {1, 0, 0, 0} | 2^{nd} PUCCH resource |
| | | | | from resourceList |
| | {0, 1} | {0, 1, 0} | {0, 1, 0, 0} | 3^{rd} PUCCH resource |
| | | | | from resourceList |
| | | {1, 1, 0} | {1, 1, 0, 0} | 4^{th} PUCCH resource |
| | | | | from resourceList |
| | | {0, 0, 1} | {0, 0, 1, 0} | 5^{th} PUCCH resource |
| | | | | from resourceList |
| | | {1, 0, 1} | {1, 0, 1, 0} | 6^{th} PUCCH resource |
| | | | | from resourceList |
| | | {0, 1, 1} | {0, 1, 1, 0} | 7^{th} PUCCH resource |
| | | | | from resourceList |
| | | | {1, 1, 1, 0} | 8^{th} PUCCH resource |
| | | | | from resourceList |
| | | | {0, 0, 0, 1} | 9^{th} PUCCH resource |
| | | | | from resourceList |
| | | | {1, 0, 0, 1} | 10^{th} PUCCH resource |
| | | | | from resourceList |
| | | | {0, 1, 0, 1} | 11^{th} PUCCH resource |
| | | | | from resourceList |
| | | | {1, 1, 0, 1} | 12^{th} PUCCH resource |
| | | | | from resourceList |
| | | | {0, 0, 1, 1} | 13^{th} PUCCH resource |
| | | | | from resourceList |
| | | | {1, 0, 1, 1} | 14^{th} PUCCH resource |
| | | | | from resourceList |
| | | | {0, 1, 1, 1} | 15^{th} PUCCH resource |
| | | | | from resourceList |

### The Multiplexing of the HARQ-ACK

In some embodiments, the HARQ-ACK information for the first signaling is multiplexing with other HARQ-ACK information for PDSCH scheduling, the HARQ-ACK information bits can be ordered according to the order of receptions of the first signalings and the scheduling DCI.

In some embodiments, the HARQ-ACK information transmission occasion for the first signaling overlaps with a CSI report occasion an or a SR. If the HARQ-ACK information and the CSI report is allowed to be transmitted on the same resource, the HARQ-ACK information with or without SR and the CSI report will be multiplexed in same PUCCH resource. Otherwise, the UE drops the CSI report(s) and includes only HARQ-ACK information, with or without SR, in the PUCCH.

In some embodiments, when the HARQ-ACK information transmission occasion for the first signaling overlaps with other UCIs such as an SR (scheduling request), a CSI (channel state information) report or HARQ-ACK information for other signalings, the UE drops other UCIs and includes only the HARQ-ACK information for the first signaling in the PUCCH.

In some embodiments, when the HARQ-ACK information transmission occasion for the first signaling overlaps with other UCIs such as the SR, the CSI report or the HARQ-ACK information for other signalings, the UE determines the information for PUCCH transmissions according to the priority of the UCI. If the priority of the HARQ-ACK information for the first signaling is higher than that of other UCIs, the UE drops other UCIs and includes only the HARQ-ACK information for the first signaling in the PUCCH. If the priority of the HARQ-ACK information for the first signaling is lower than that of other UCIs, the UE drops the HARQ-ACK information for the first signaling and includes other UCI in the PUCCH. If the priority of the HARQ-ACK information for the first signaling is equal to that of other UCIs, the UE drops other UCIs and includes only the HARQ-ACK information for the first signaling in the PUCCH.

In some embodiments, when the HARQ-ACK information transmission occasion for the first signaling overlaps with other HARQ-ACK information for the first signaling, only one HARQ-ACK information is transmitted. In some embodiments, only the HARQ-ACK information corresponding to the earliest first signaling is transmitted. In some other embodiments, only the HARQ-ACK information corresponding to the latest first signaling is transmitted.

In some embodiments, the UE does not expect that a PUCCH carries more than one HARQ-ACK information for the first signaling.

In some embodiments, the UE does not expect to transmit other HARQ-ACK information (e.g., for signaling/data other than the first signaling) on the PUCCHs that transmit the HARQ-ACK information for the first signaling.

In some embodiments, the UE provides the HARQ-ACK information with the ACK value when a first signaling is detected. If a first signaling is transmitted and no HARQ-ACK information is provided, the gNB re-transmits the first signaling until HARQ-ACK information with the ACK value is received.

In some other embodiments, the UE provides the HARQ-ACK information with the NACK value when a first signaling is not detected correctly. If a first signaling is transmitted and the HARQ-ACK information with the NACK value is provided, the gNB re-transmits the first signaling until the first signaling is correctly detected.

In some embodiments, the UE receives the configuration of the cell DTX and/or the cell DRX before the first signaling is transmitted. In some embodiments, the UE receives the configuration of the cell DTX and/or the cell DRX no matter whether the first signaling is transmitted. In some embodiments, the cell DTX and/or the cell DRX configuration is activated when the configuration is configured. In some embodiments, the cell DTX and/or the cell DRX takes effect immediately after the configuration is completed.

In some embodiments, the configuration of the cell DTX and/or the cell DRX comprises at least one of a cell DTX DRX cycle, a cell DTX/DRX ON duration timer, a cell DTX/DRX inactivity timer, a cell DTX/DRX offset, a cell DTX/DRX pattern or pattern index.

In some embodiments, the UE receives configuration of the cell DTX or the cell DRX, wherein the cell DTX or the cell DRX configuration determines an active time and/or a non-active time of the cell DTX or the cell DRX.

During the non-active cell DTX time, the UE does not receive one or more first channels or signals. In some embodiments, the first channel or signals includes at least one of SPS (Semi Persistent Scheduling) PDSCH (physical downlink shared channel), UE specific PDCCH (physical downlink control channel), or CSI-RS for channel measurement.

During the non-active cell DRX time, the UE does not transmit one or more second channels or signals. In some embodiments, the second channel or signals includes at least one of CG (configured grant) PUSCH (physical uplink shared channel), SRS (sounding reference signal), or SR.

In some embodiments, when the SPS PDSCH transmission occasion overlaps with the non-active time of cell DTX, UE generates a NACK bit for the corresponding SPS PDSCH, or doesn't generate any HARQ-ACK information for the corresponding SPS PDSCH. In some embodiments, a HARQ-ACK codebook type corresponding to the HARQ-ACK information is semi-persistent or type one.

In some embodiments, if a transmission occasion of a repetition of PDSCH overlaps with the non-active time of cell DTX, the nominal/actual repetition times of the PDSCH is increased by one, or the repetition of PDSCH overlapping with the non-active time of cell DTX is not counted in the actual repetition times of the PDSCH

In some embodiments, if a transmission occasion of a repetition of PUSCH/PUCCH overlaps with the non-active time of cell DRX, the nominal/actual repetition times of PUSCH/PUCCH is increased by one, or the repetition of PUSCH/PUCCH overlapping with the non-active time of cell DTX is not counted in the actual repetition times of the PUSCH/PUCCH.

In some embodiments, if an uplink transmission occasion overlaps with the non-active time of the cell DRX, the uplink transmission is deferred to a valid uplink transmission occasion. In some embodiments, the valid uplink transmission occasion is determined by at least one a cell DRX configuration, an activation or de-activation indication by the first signaling, a slot format determined by higher layer signaling and/or DCI format 2-0. For example, the valid uplink transmission occasion is an uplink transmission occasion that is not overlapped with cell DRX non-active time. For example, the valid uplink transmission occasion is an earliest valid uplink transmission occasion. In some examples, the uplink transmission carries HARQ-ACK indication for the first signaling, a DL transmission, or a DL SPS transmission.

In some embodiments, the UE performs a next action if at least one of the following conditions is satisfied:
the UE is provided pdsch-HARQ-ACK-CodebookList;
the UE can be indicated by pdsch-HARQ-ACK-CodebookList to generate one or two HARQ-ACK codebooks;
the UE is indicated to generate one HARQ-ACK codebook;
the HARQ-ACK codebook is associated with a PUCCH of priority index 0;
the UE multiplexes in a same HARQ-ACK codebook only HARQ-ACK information associated with a same priority index;
at least one of the first PDSCH/DL reception corresponding to a HARQ-ACK information associated with a same priority index is dropped or is canceled/suspended during the cell DTX non active period;
at least one of the first PDSCH/DL reception corresponding to a HARQ-ACK information is dropped or is canceled/suspended during the cell DTX non-active period;
at least one of the first PDSCH/DL reception is dropped or is canceled/suspended during the cell DTX non-active period;
a HARQ-ACK codebook type is semi-static or type one;
at least one of the first PDSCH/DL reception corresponding to the HARQ-ACK information associated with a same priority index is transmitted during the cell DTX nonactive periods;
the uplink transmission occasions of the HARQ-ACK information corresponding to at least one of the first PDSCH/DL reception overlaps with cell DRX non active periods;
the UE receives a first PDSCH without receiving a corresponding PDCCH;
the UE receives a first PDCCH indicating a SPS PDSCH release;
the UE is indicated by a higher layer parameter with a HARQ-ACK codebook index for multiplexing the corresponding HARQ-ACK information bit for at least two of a first PDSCH/DL reception;
the HARQ-ACK codebook index indicated by higher layer parameter corresponds to the PDSCH/DL reception which is dropped/canceled/suspended during cell DTX non-active period;
the HARQ-ACK codebook index indicated by higher layer parameter corresponds to the PDSCH/DL reception which overlaps with cell DTX non-active period; or
at least two of the first PDSCH/DL receptions are associated with a same priority index, wherein the first PDSCH/DL includes at least one of a PDCCH indicating a SPS PDSCH release, a SPS PDSCH, a PDSCH scheduled by PDCCH, a PDSCH not scheduled by PDCCH.

In some embodiments, the next action includes at least one of the followings:
the UE generates one corresponding HARQ-ACK information bit for the first PDSCH/DL reception as ‘NACK’;
the UE does not generate the corresponding HARQ-ACK information bit for the first PDSCH/DL reception;
the UE does not feedback the corresponding HARQ-ACK information for the first PDSCH/DL reception; or
the UE only feeds back the corresponding HARQ-ACK information for the second PDSCH/DL reception other than the first PDSCH/DL reception.

In some embodiments, the HARQ feedback of the second PDSCH/DL reception is multiplexed with that of the first PDSCH/DL reception. In some embodiments, the second PDSCH/DL reception includes at least one of a PDCCH indicating a SPS PDSCH release, a SPS PDSCH, a PDSCH with PDCCH scheduling, or a PDSCH without PDCCH scheduling.

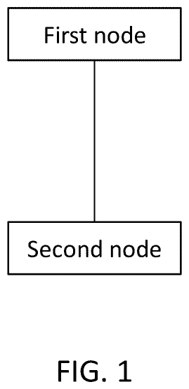

FIG. 1 shows a schematic diagram of a network (architecture) according to an embodiment of the present disclosure. In FIG. 1, a first node communicates with a second node. In an embodiment, the first node is a base station (e.g., gNB) and the second node is a UE.

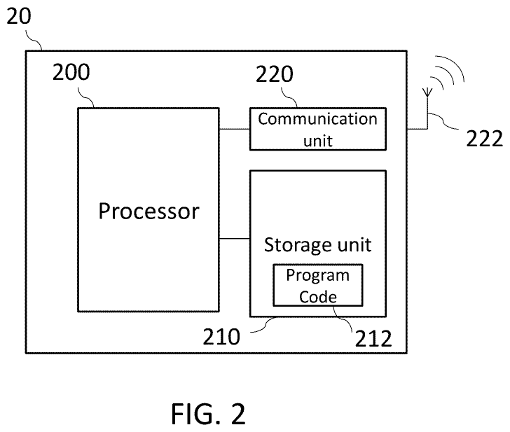

FIG. 2 relates to a schematic diagram of a wireless terminal 20 according to an embodiment of the present disclosure. The wireless terminal 20 may be a user equipment (UE), a mobile phone, a laptop, a tablet computer, an electronic book or a portable computer system and is not limited herein. The wireless terminal 20 may include a processor 200 such as a microprocessor or Application Specific Integrated Circuit (ASIC), a storage unit 210 and a communication unit 220. The storage unit 210 may be any data storage device that stores a program code 212, which is accessed and executed by the processor 200. Embodiments of the storage unit 210 include but are not limited to a subscriber identity module (SIM), read-only memory (ROM), flash memory, random-access memory (RAM), hard-disk, and optical data storage device. The communication unit 220 may a transceiver and is used to transmit and receive signals (e.g., messages or packets) according to processing results of the processor 200. In an embodiment, the communication unit 220 transmits and receives the signals via at least one antenna 222 shown in FIG. 2.

In an embodiment, the storage unit 210 and the program code 212 may be omitted and the processor 200 may include a storage unit with stored program code.

The processor 200 may implement any one of the steps in exemplified embodiments on the wireless terminal 20, e.g., by executing the program code 212.

The communication unit 220 may be a transceiver. The communication unit 220 may as an alternative or in addition be combining a transmitting unit and a receiving unit configured to transmit and to receive, respectively, signals to and from a wireless network node (e.g., a base station).

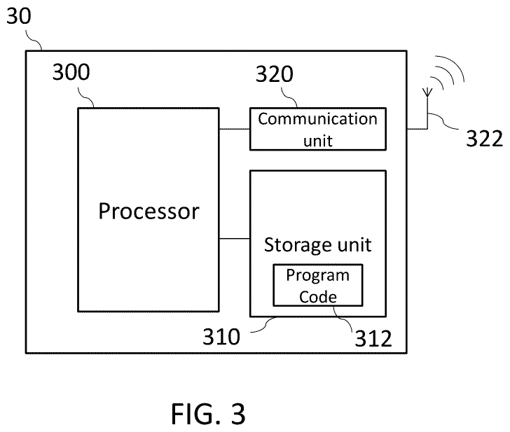

FIG. 3 relates to a schematic diagram of a wireless network node 30 according to an embodiment of the present disclosure. The wireless network node 30 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 30 may comprise (perform) at least one network function such as an access and mobility management function (AMF), a session management function (SMF), a user place function (UPF), a policy control function (PCF), an application function (AF), etc. The wireless network node 30 may include a processor 300 such as a microprocessor or ASIC, a storage unit 310 and a communication unit 320. The storage unit 310 may be any data storage device that stores a program code 312, which is accessed and executed by the processor 300. Examples of the storage unit 310 include but are not limited to a SIM, ROM, flash memory, RAM, hard-disk, and optical data storage device. The communication unit 320 may be a transceiver and is used to transmit and receive signals (e.g., messages or packets) according to processing results of the processor 300. In an example, the communication unit 320 transmits and receives the signals via at least one antenna 322 shown in FIG. 3.

In an embodiment, the storage unit 310 and the program code 312 may be omitted. The processor 300 may include a storage unit with stored program code.

The processor 300 may implement any steps described in exemplified embodiments on the wireless network node 30, e.g., via executing the program code 312.

The communication unit 320 may be a transceiver. The communication unit 320 may as an alternative or in addition be combining a transmitting unit and a receiving unit configured to transmit and to receive, respectively, signals to and from a wireless terminal (e.g., a user equipment or another wireless network node).

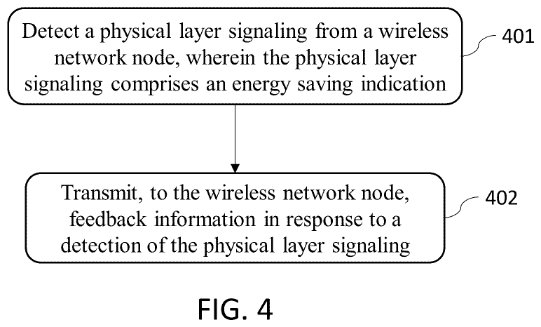

FIG. 4 shows a flowchart of a method according to an embodiment of the present disclosure. The method shown in FIG. 4 may be used in a wireless terminal (e.g., UE) and comprises the following steps:

Step 401: Detect a physical layer signaling from a wireless network node, wherein the physical layer signaling comprises an energy saving indication.

Step 402: Transmit, to the wireless network node, feedback information in response to a detection of the physical layer signaling.

In FIG. 4, the wireless terminal monitors/detects a physical layer signaling (e.g., the aforementioned first signaling) comprising an energy saving indication from a wireless network node (e.g., gNB). Based on a monitor/detection (result) of the physical layer signaling, the wireless terminal transmit feedback information to the wireless network node.

In an embodiment, the energy saving indication comprises at least one of:
an indication to indicate an activation or deactivation of a cell discontinuous communication configuration, wherein the cell discontinuous communication configuration is for a cell discontinuous transmission (DTX) or a cell discontinuous reception (DRX),
an indication to indicate one or more power offsets,
an indication to indicate one or more antenna ports,
an indication to indicate one or more channel state information reference signal (CSI-RS) resources,
an indication indicates one or more CSI-RS resources groups/sets,
an indication indicates one or more subsets of antenna port indices, or
an indication indicates one or more CSI report configurations or sub-configurations.

In an embodiment, the feedback information is hybrid automatic repeat request (HARQ) acknowledge information.

In an embodiment, the wireless terminal transmits, to the wireless network node, both the feedback information having a positive acknowledgement value (i.e., ACK) in response to a successful detection of the physical layer signaling and the feedback information having a negative acknowledgement (i.e., NACK) value in response to a failed detection of the physical layer signaling (see, e.g., the embodiments for the first HARQ-ACK reporting mode).

In an embodiment, the wireless terminal transmits, to the wireless network node, only the feedback information having the positive acknowledgement value in response to the successful detection of the first signaling (see, e.g., the embodiments for the second HARQ-ACK reporting mode).

In an embodiment, the wireless terminal does not transmit the feedback information having the negative acknowledgement value in response to the failed detection of the first signaling (see, e.g., the embodiments for the second HARQ-ACK reporting mode).

In an embodiment, the wireless terminal transmits, to the wireless network node, only the feedback information having the negative acknowledgement value in response to the failed detection of the physical layer signaling (see, e.g., the embodiments for the third HARQ-ACK reporting mode).

In an embodiment, the wireless terminal does not transmit the feedback information having the positive acknowledgement value in response to the successful detection of the physical layer signaling (see, e.g., the embodiments for the third HARQ-ACK reporting mode).

In an embodiment, the feedback information is transmitted N symbols after a pre-defined symbol, wherein N is a positive integer. The pre-defined symbol may be the first symbol or the last symbol of a transmission occasion for the physical layer signaling.

In an embodiment, N is determined based on at least one of:
a smallest subcarrier spacing (SCS) configuration between a first SCS configuration of the physical layer signaling and a second SCS configuration of a physical uplink control channel carrying the feedback information,
processing capability of the wireless terminal,
a pre-determined value, or
one or more fixed value configured by high layer parameter.

In an embodiment, the detection of the physical layer signaling is in a slot n and the feedback information in response to the detection of the physical layer signaling is transmitted in a slot n+k, wherein n is an integer and k is a positive integer.

In an embodiment, k is indicated by the physical layer signaling, configured by a high layer parameter or predetermined.

In an embodiment, the feedback information comprises one or more information bits corresponding to one or more physical layer signalings, In this embodiment, the one or more HARQ-ACK information bits are transmitted in the same slot. Under such condition, the one or more HARQ-ACK information bits may be joint coded or presented by the same PUCCH resource or sequence. In addition, the one or more physical layer signalings may be transmitted in different occasions and comprise the same or different indication information.

In an embodiment, the feedback information is transmitted on a dedicated physical uplink control channel (PUCCH) resource set comprising one or more PUCCH resources configured for the feedback information.

In an embodiment, the feedback information is transmitted on a common PUCCH resource set comprising one or more PUCCH resources.

In an embodiment, the feedback information is transmitted via at least one of a physical uplink control channel (PUCCH) format 0 or a PUCCH format 1.

In an embodiment, at least one of a PUCCH resource or PUCCH resource set used for transmitting at least one feedback bit of the feedback information is determined based on at least one of a pre-determined resource, a predetermined resource set, a length of the HARQ-ACK information bits, a PUCCH resource set index, a PUCCH resource index, a number of control channel elements (CCEs) in a CORESET of a physical layer signaling reception, an index of a first CCE for the physical layer signaling reception, a value of the PUCCH resource indicator field in the DCI format, or at least one bit value of the at least one feedback bit.

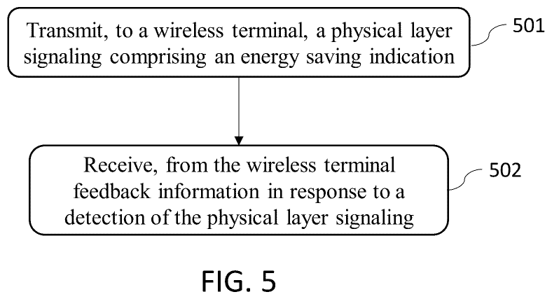

FIG. 5 shows a flowchart of a method according to an embodiment of the present disclosure. The method shown in FIG. 5 may be used in a wireless network node (e.g., gNB) and comprises the following steps:

Step 501: Transmit, to a wireless terminal, a physical layer signaling comprising an energy saving indication.

Step 502: Receive, from the wireless terminal feedback information in response to a detection of the physical layer signaling.

In an embodiment, the energy saving indication comprises at least one of:
an indication to indicate an activation or deactivation of a cell discontinuous communication configuration, wherein the cell discontinuous communication configuration is for a cell discontinuous transmission (DTX) or a cell discontinuous reception (DRX),
an indication to indicate one or more power offsets,
an indication to indicate one or more antenna ports,
an indication to indicate one or more channel state information reference signal (CSI-RS) resources,
an indication indicates one or more CSI-RS resources groups/sets,
an indication indicates one or more subsets of antenna port indices, or
an indication indicates one or more CSI report configurations or sub-configurations.

In an embodiment, the feedback information is hybrid automatic repeat request (HARQ) acknowledge information.

In an embodiment, the feedback information comprises the positive acknowledgement value in response to the successful detection of the physical layer signaling and the negative acknowledgement value in response to the failed detection of the physical layer signaling (see, e.g., the embodiments for the first HARQ-ACK reporting mode).

In an embodiment, the feedback information comprises only the positive acknowledgement value in response to the successful detection of the physical layer signaling (see, e.g., the embodiments for the second HARQ-ACK reporting mode).

In an embodiment, the feedback information comprises only the negative acknowledgement value in response to the failed detection of the physical layer signaling (see, e.g., the embodiments for the third HARQ-ACK reporting mode).

In an embodiment, the feedback information is received N symbols after a pre-defined symbol, wherein N is a positive integer, and the pre-defined symbol is the first symbol or the last symbol of a transmission occasion for the physical layer signaling.

In an embodiment, N is determined based on at least one of:
a smallest subcarrier spacing (SCS) configuration between a first SCS configuration of the physical layer signaling and a second SCS configuration of a physical uplink control channel carrying the feedback information,
processing capability of the wireless terminal,
a pre-determined value, or
one or more fixed value configured by high layer parameter.

In an embodiment, the detection of the physical layer signaling is in a slot n and the feedback information in response to the detection of the physical layer signaling is received in a slot n+k, wherein n is an integer and k is a positive integer.

In an embodiment, k is indicated by the physical layer signaling, configured by a high layer parameter or predetermined.

In an embodiment, the feedback information comprises one or more information bits corresponding to one or more physical layer signalings, In this embodiment, the one or more HARQ-ACK information bits are transmitted in the same slot. The one or more HARQ-ACK information bits are joint coded or presented by the same PUCCH resource or sequence, and the one or more physical layer signalings are transmitted in different occasions and comprise the same or different indication information.

In an embodiment, the feedback information is received on a dedicated physical uplink control channel (PUCCH) resource set comprising one or more PUCCH resources configured for the feedback information.

In an embodiment, the feedback information is received on a common PUCCH resource set comprising one or more PUCCH resources.

In an embodiment, the feedback information is received via at least one of a physical uplink control channel (PUCCH) format 0 or a PUCCH format 1.

In an embodiment, at least one of a PUCCH resource or PUCCH resource set used for transmitting at least one feedback bit of the feedback information is determined based on at least one of a pre-determined resource, a predetermined resource set, a length of the HARQ-ACK information bits, a PUCCH resource set index, a PUCCH resource index, a number of control channel elements (CCEs) in a CORESET of a physical layer signaling reception, an index of a first CCE for the physical layer signaling reception, a value of the PUCCH resource indicator field in the DCI format, or at least one bit value of the at least one feedback bit.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in a wireless terminal, the method comprising:
detecting a physical layer signaling from a wireless network node, wherein the physical layer signaling comprises an energy saving indication, and
transmitting, to the wireless network node, feedback information in response to a detection of the physical layer signaling.

2. The wireless communication method of claim 1, wherein the energy saving indication comprises at least one of:
an indication to indicate an activation or deactivation of a cell discontinuous communication configuration, wherein the cell discontinuous communication configuration is for a cell discontinuous transmission (DTX) or a cell discontinuous reception (DRX),
an indication to indicate one or more power offsets,
an indication to indicate one or more antenna ports,
an indication to indicate one or more channel state information reference signal (CSI-RS) resources,
an indication indicates one or more CSI-RS resources groups/sets,
an indication indicates one or more subsets of antenna port indices, or
an indication indicates one or more CSI report configurations or sub-configurations.

3. The wireless communication method of claim 1, wherein the feedback information is hybrid automatic repeat request (HARQ) acknowledge information.

4. The wireless communication method of claim 1, wherein transmitting, to the wireless network node, the feedback information in response to the detection of the physical layer signaling comprises at least one of:
transmitting, to the wireless network node, the feedback information having a positive acknowledgement value in response to a successful detection of the physical layer signaling and the feedback information having a negative acknowledgement value in response to a failed detection of the physical layer signaling,
transmitting, to the wireless network node, only the feedback information having the positive acknowledgement value in response to the successful detection of the physical layer signaling;
not transmitting, to the wireless network node, the feedback information having the negative acknowledgement value in response to the failed detection of the physical layer signaling;
transmitting, to the wireless network node, only the feedback information having the negative acknowledgement value in response to the failed detection of the physical layer signaling; or
not transmitting, to the wireless network node, the feedback information having the positive acknowledgement value in response to the successful detection of the physical layer signaling.

5. The wireless communication method of claim 1, wherein the feedback information is transmitted N symbols after a pre-defined symbol, wherein N is a positive integer, and the pre-defined symbol is the first symbol or the last symbol of a transmission occasion for the physical layer signaling.

6. The wireless communication method of claim 5, wherein N is determined based on at least one of:
a smallest subcarrier spacing (SCS) configuration between a first SCS configuration of the physical layer signaling and a second SCS configuration of a physical uplink control channel carrying the feedback information,
processing capability of the wireless terminal,
a pre-determined value, or
one or more fixed value configured by high layer parameter.

7. The wireless communication method of claim 1, wherein the detection of the physical layer signaling is in a slot n and the feedback information in response to the detection of the physical layer signaling is transmitted in a slot n+k, wherein n is an integer and k is a positive integer.

8. The wireless communication method of claim 7, wherein k is indicated by the physical layer signaling, configured by a high layer parameter or predetermined.

9. The wireless communication method of claim 1, wherein the feedback information comprises one or more information bits corresponding to one or more physical layer signalings,
wherein the one or more HARQ-ACK information bits are transmitted in the same slot,
wherein the one or more HARQ-ACK information bits are joint coded or presented by the same PUCCH resource or sequence, and
wherein the one or more physical layer signalings are transmitted in different occasions and comprise the same or different indication information.

10. The wireless communication method of claim 1, wherein:
the feedback information is transmitted on a dedicated physical uplink control channel (PUCCH) resource set comprising one or more PUCCH resources configured for the feedback information, or
the feedback information is transmitted on a common PUCCH resource set comprising one or more PUCCH resources.

11. The wireless communication method of claim 1, wherein the feedback information is transmitted via at least one of a physical uplink control channel (PUCCH) format 0 or a PUCCH format 1.

12. The wireless communication method of claim 1, wherein at least one of a PUCCH resource or PUCCH resource set used for transmitting at least one feedback bit of the feedback information is determined based on at least one of a pre-determined resource, a predetermined resource set, a length of the HARQ-ACK information bits, a PUCCH resource set index, a PUCCH resource index, a number of control channel elements (CCEs) in a CORESET of a physical layer signaling reception, an index of a first CCE for the physical layer signaling reception, a value of the PUCCH resource indicator field in the DCI format, or at least one bit value of the at least one feedback bit.

13. A wireless communication method for use in a wireless network node, the method comprising:
transmitting, to a wireless terminal, a physical layer signaling comprising an energy saving indication, and
receiving, from the wireless terminal feedback information in response to a detection of the physical layer signaling.

14. The wireless communication method of claim 13, wherein the energy saving indication comprises at least one of:
an indication to indicate an activation or deactivation of a cell discontinuous communication configuration, wherein the cell discontinuous communication configuration is for a cell discontinuous transmission (DTX) or a cell discontinuous reception (DRX),
an indication to indicate one or more power offsets,
an indication to indicate one or more antenna ports,
an indication to indicate one or more channel state information reference signal (CSI-RS) resources,
an indication indicates one or more CSI-RS resources groups/sets,
an indication indicates one or more subsets of antenna port indices, or
an indication indicates one or more CSI report configurations or sub-configurations.

15. (canceled)

16. The wireless communication method of claim 13, wherein the feedback information comprises:
a positive acknowledgement value in response to a successful detection of the physical layer signaling and a negative acknowledgement value in response to a failed detection of the physical layer signaling,
only the positive acknowledgement value in response to the successful detection of the physical layer signaling, or
only the negative acknowledgement value in response to the failed detection of the physical layer signaling.

17-24. (canceled)

25. A wireless terminal, comprising:
a processor, configured to detect a physical layer signaling from a wireless network node, wherein the physical layer signaling comprises an energy saving indication, and
a communication unit, configured to transmitting, to the wireless network node, feedback information in response to a detection of the physical layer signaling.

26. The wireless terminal of claim 25, wherein the energy saving indication comprises at least one of:
an indication to indicate an activation or deactivation of a cell discontinuous communication configuration, wherein the cell discontinuous communication configuration is for a cell discontinuous transmission (DTX) or a cell discontinuous reception (DRX),
an indication to indicate one or more power offsets,
an indication to indicate one or more antenna ports,
an indication to indicate one or more channel state information reference signal (CSI-RS) resources,
an indication indicates one or more CSI-RS resources groups/sets,
an indication indicates one or more subsets of antenna port indices, or
an indication indicates one or more CSI report configurations or sub-configurations.

27-28. (canceled)

29. A computer program product comprising a computer-readable program medium code stored thereupon, the code, when executed by a processor, causing the processor to implement a wireless communication method recited in claim 1.

30. The wireless terminal of claim 25, wherein the feedback information is hybrid automatic repeat request (HARQ) acknowledge information.

31. A computer program product comprising a computer-readable program medium code stored thereupon, the code, when executed by a processor, causing the processor to implement a wireless communication method recited in claim 13.
